(19) United States
(12) Patent Application Publication
(10) Pub. No.: US 2026/0179311 A1
(43) Pub. Date: Jun. 25, 2026

(54) INFORMATION PROCESSING DEVICE, INFORMATION PROCESSING METHOD, AND PROGRAM

(71) Applicant: SONY GROUP CORPORATION, Tokyo (JP)

(72) Inventors: Ryosuke MURATA, Tokyo (JP); Yuki TAKEDA, Tokyo (JP); Shunichi HOMMA, Tokyo (JP); Takaaki KATO, Tokyo (JP); Yoshikatsu NAKAJIMA, Tokyo (JP); Manabu KAWASHIMA, Tokyo (JP); Shin MIKAMI, Tokyo (JP); Fujio ARAI, Tokyo (JP)

(21) Appl. No.: 19/124,828

(22) PCT Filed: Oct. 16, 2023
(86) PCT No.: PCT/JP2023/037326

§ 371 Date: Apr. 25, 2025

(30) Foreign Application Priority Data
Nov. 1, 2022 (JP) 2022-175313

(51) Int. Cl. G06T 15/20

(52) U.S. Cl. CPC G06T 15/205; G06T 15/20

(57) ABSTRACT

The present technology relates to an information processing device, an information processing method, and a program that enable easy confirmation of a place where localization is likely to succeed and a place where localization is likely to fail. An information processing device according to the present technology includes: an imaging target direction calculation unit that calculates an imaging target direction of a landmark included in a 3D map generated on the basis of a plurality of captured images obtained by capturing an image of a real space; a viewpoint acquisition unit that acquires a virtual viewpoint of a user for the 3D map; and a drawing unit that draws a first image showing a state of the 3D map and superimposes a second image based on an imaging target direction of the landmark and the virtual viewpoint on the first image. The present technology can be applied to, for example, an information processing device that visualizes a 3D map used in the VPS technology.

### TECHNICAL FIELD

The present technology relates to an information processing device, an information processing method, and a program, and more particularly, to an information processing device, an information processing method, and a program that enable easy confirmation of a place where localization is likely to succeed and a place where localization is likely to fail.

### BACKGROUND ART

In recent years, a visual positioning system (VPS) technology for estimating (localizing) a position and a posture of a user terminal from a captured image captured by the user terminal using a 3D map has been developed. In the VPS, the position and the posture of the user terminal can be estimated with higher accuracy than global positioning system (GPS). The VPS technology is used in, for example, an augmented reality (AR) application (see, for example, Patent Document 1).

### CITATION LIST

### Patent Document

Patent Document 1: Japanese Patent Application Laid-Open No. 2022-24169

### SUMMARY OF THE INVENTION

### Problems to be Solved by the Invention

Actually, localization cannot be performed anywhere in the real space corresponding to the 3D map, and there are places where localization is likely to succeed and places where localization is likely to fail.

The 3D map is not, like a general map, in a format that can be understood by a person, but is held in a form of a machine-readable database. Therefore, it is difficult for a developer of an AR application or the like to determine a place where localization is likely to succeed and a place where localization is likely to fail in the real space corresponding to the 3D map.

The present technology has been made in view of such a situation, and makes it possible to easily confirm a place where localization is likely to succeed and a place where localization is likely to fail.

### Solutions to Problems

An information processing device according to one aspect of the present technology includes: an imaging target direction calculation unit that calculates an imaging target direction of a landmark included in a 3D map generated on the basis of a plurality of captured images obtained by capturing an image of a real space; a viewpoint acquisition unit that acquires a virtual viewpoint of a user for the 3D map; and a drawing unit that draws a first image showing a state of the 3D map and superimposes a second image based on an imaging target direction of the landmark and the virtual viewpoint on the first image.

In an information processing method according to one aspect of the present technology, an information processing device executes calculating an imaging target direction of a landmark included in a 3D map generated on the basis of a plurality of captured images obtained by capturing an image of a real space; acquiring a virtual viewpoint of a user for the 3D map; and drawing a first image showing a state of the 3D map and superimposing a second image based on an imaging target direction of the landmark and the virtual viewpoint on the first image.

A program according to one aspect of the present technology causes a computer to execute: calculating an imaging target direction of a landmark included in a 3D map generated on the basis of a plurality of captured images obtained by capturing an image of a real space; acquiring a virtual viewpoint of a user for the 3D map; and drawing a first image showing a state of the 3D map and superimposing a second image based on an imaging target direction of the landmark and the virtual viewpoint on the first image.

In one aspect of the present technology, an imaging target direction of a landmark included in a 3D map generated on the basis of a plurality of captured images obtained by capturing an image of a real space is calculated, a virtual viewpoint of a user for the 3D map is acquired; and a first image showing a state of the 3D map is drawn and a second image based on an imaging target direction of the landmark and the virtual viewpoint is superimposed on the first image.

### BRIEF DESCRIPTION OF DRAWINGS

FIG. 1 is a diagram illustrating an application example of a VPS technology.

FIG. 2 is a diagram illustrating an overview of the VPS technology.

FIG. 3 is a diagram for explaining a method of estimating a KF viewpoint and a landmark position.

FIG. 4 is a diagram for explaining a flow of localization.

FIG. 5 is a diagram for explaining a flow of localization.

FIG. 6 is a diagram for explaining a flow of localization.

FIG. 7 is a diagram illustrating an example of an environment unsuitable for localization.

FIG. 8 is a diagram illustrating an example in which localization fails due to a shortage of key frames included in a 3D map.

FIG. 9 is a diagram illustrating an example of a device for solving failure in localization.

FIG. 10 is a diagram illustrating an example of an imaging target direction of a landmark.

FIG. 11 is a diagram illustrating a display example of a 3D view.

FIG. 12 is a block diagram illustrating a configuration example of an information processing device according to a first embodiment of the present technology.

FIG. 13 is a flowchart for explaining processing performed by the information processing device.

FIG. 14 is a flowchart for explaining imaging target direction calculation processing performed in step S3 of FIG. 13.

FIG. 15 is a diagram illustrating an example of a display color of a landmark object.

FIG. 16 is a diagram illustrating an example of an overhead view of a 3D map and a virtual viewpoint image.

FIG. 17 is a diagram illustrating an example of a landmark object expressing an imaging target direction with a color.

FIG. 18 is a diagram illustrating an example of a landmark object expressing an imaging target direction with a shape.

FIG. 19 is a diagram illustrating an example of performing AR display of a landmark object.

FIG. 20 is a diagram illustrating an example of a 3D view in which information according to a landmark score is displayed.

FIG. 21 is a diagram illustrating an example of a method of generating a heat map.

FIG. 22 is a diagram illustrating an example of a UI for inputting an operation of setting an evaluation direction.

FIG. 23 is a block diagram illustrating a configuration example of the information processing device according to a second embodiment of the present technology.

FIG. 24 is a flowchart for explaining the processing performed by the information processing device.

FIG. 25 is a diagram illustrating another example of a UI for inputting an operation of setting an evaluation direction.

FIG. 26 is a diagram illustrating an example of a plurality of evaluation directions set for each grid.

FIG. 27 is a block diagram illustrating a configuration example of hardware of a computer.

### MODE FOR CARRYING OUT THE INVENTION

Hereinafter, modes for carrying out the present technology will be described. The description is given in the following order.
1. Overview of VPS Technology
2. First Embodiment
3. Second Embodiment

### 1. Overview of VPS Technology

In recent years, a VPS technology for estimating a position and a posture of a user terminal from a captured image captured by the user terminal using a 3D map has been developed. Hereinafter, estimating the position and the posture of the user terminal using the 3D map and the captured image is referred to as localization.

Similarly to the VPS, the GPS is also a system that estimates the position of the user terminal. In the GPS, the estimation accuracy of the position of the user terminal is in meters. On the other hand, in the VPS, the estimation accuracy of the position of the user terminal is higher than that in the GPS (in units of several tens to several centimeters). Furthermore, unlike the GPS, the VPS can be used in an indoor environment.

The VPS technology is used for, for example, an AR application. It is known by the VPS technology where the application user who carries the user terminal is in the real space and where the user terminal is directed. Therefore, for example, in a case where the application user directs the user terminal to a predetermined place in the real space where the AR virtual object is virtually arranged, the AR application in which the AR virtual object is displayed on the display of the user terminal can be realized using the VPS technology.

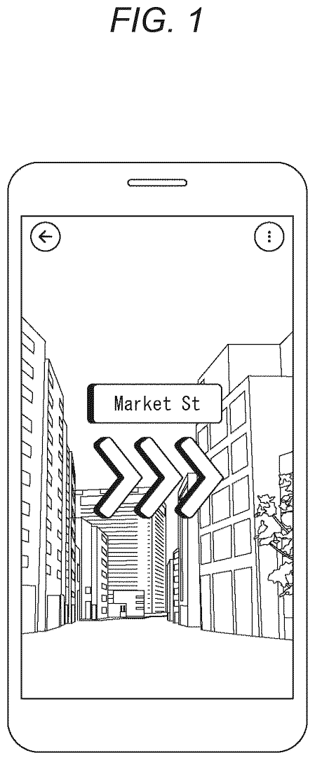

FIG. 1 is a diagram illustrating an application example of the VPS technology.

For example, when the application user faces a camera provided on a smartphone as a user terminal in a direction in which the application user faces in a town, a virtual object of an arrow indicating a direction of a destination is displayed on a display of the smartphone as being superimposed on a captured image captured by the camera, as illustrated in FIG. 1.

As described above, the VPS technology is used for navigation using AR virtual objects, entertainment, and the like.

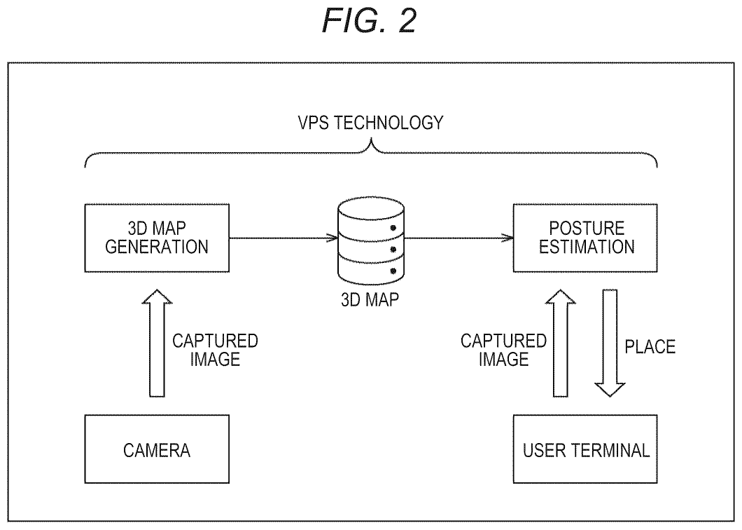

FIG. 2 is a diagram illustrating an outline of the VPS technology.

As illustrated in FIG. 2, the VPS technology includes two technologies of a technology of generating a 3D map in advance and a technology of performing localization using the 3D map.

The 3D map is generated on the basis of a group of captured images captured by a camera in a plurality of positions and postures in a real space where localization is desired. The 3D map indicates a state of the entire real space in which imaging has been performed. The 3D map is configured by registering image information regarding a captured image captured by a camera, three-dimensional shape information indicating a shape of a real space, and the like in a database.

One of techniques for generating a 3D map is the structure from motion (SfM). The SfM is a technology of making a specific object or environment in three-dimension on the basis of a group of captured images acquired by imaging the object or environment from various positions and directions. The SfM is often used in photogrammetry technology that has attracted attention in recent years. Note that, in addition to the SfM, the 3D map can be generated by a method such as visual odometry (VO), visual inertial odometry (VIO), simultaneous localization and mapping (SLAM), or a method combining an image, light detection and ranging (LiDAR), or GPS.

In the generation of the 3D map, image information and three-dimensional shape information are estimated by various methods such as the SfM using a group of captured images captured in advance at various positions and postures in a real space where localization is desired, and these pieces of information are stored in a database in a data format that is easy to use for localization.

Specifically, the 3D map includes a KF viewpoint (imaging position and imaging direction) of a key frame selected from a group of captured images captured in advance, a position of an image feature point (key point, KP) in the key frame, a three-dimensional position (landmark position) of the image feature point, a feature amount (image feature amount) of the key point, an environment mesh indicating a shape of a real space, and the like. Hereinafter, a subject appearing at the key point portion in the key frame is referred to as a landmark. The 3D map also includes correspondence information indicating a correspondence between each key point and a landmark and a key frame in which each key point is included.

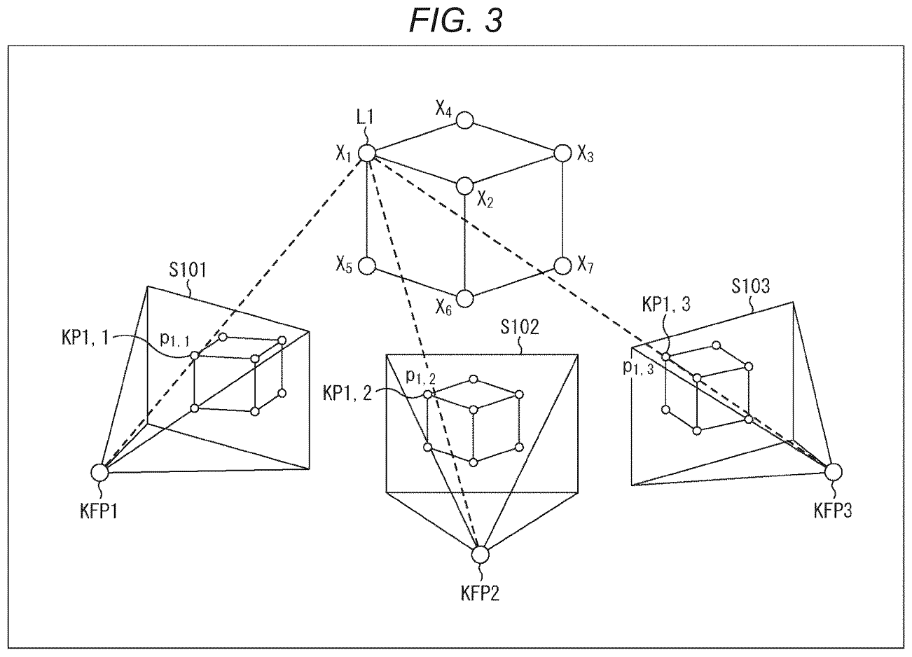

FIG. 3 is a diagram for explaining a method of estimating a KF viewpoint and a landmark position.

Image planes S101 to S103 illustrated in FIG. 3 indicate virtual image planes on which key frames KF1 to KF3 obtained by imaging the same cube in different positions and postures are projected, respectively. In the key frames KF1 to KF3, one vertex (landmark L1) of the cube commonly appears. A region in the key frame KF1 in which the landmark L1 appears (corresponding to the landmark L1) is set as a key point KP1,1, a region in the key frame KF2 is set as a key point KP1,2, and a region in the key frame KF3 is set as a key point KP1,3. In the two-dimensional coordinate system of the key frame, the position of the key point KP1,1 is indicated by p_{1,1}, the position of the key point KP1,2 is indicated by p_{1,2}, and the position of the key point KP1,3 is indicated by p_{1,3}.

In various methods such as the SfM, the landmark position x₁ of the landmark L1 is estimated by triangulation based on the positions of the key points KP1,1 to KP1,3 included in the three key frames KF1 to KF3. In addition to the estimation of the landmark position x₁, the imaging positions KFP1 to KFP3 and the imaging directions (postures) of the key frames KF1 to KF3 are also estimated on the basis of the positions of the key points KP1,1 to KP1,3.

Returning to FIG. 2, localization is performed by querying a captured image (hereinafter, referred to as a query image or a real image) captured by the user terminal with respect to the 3D map. The place (position and posture) of the user terminal estimated on the basis of the query image is supplied to the user terminal and used for displaying the AR virtual object and the like. Note that a localizable place in the real space corresponding to the 3D map is determined by the 3D map.

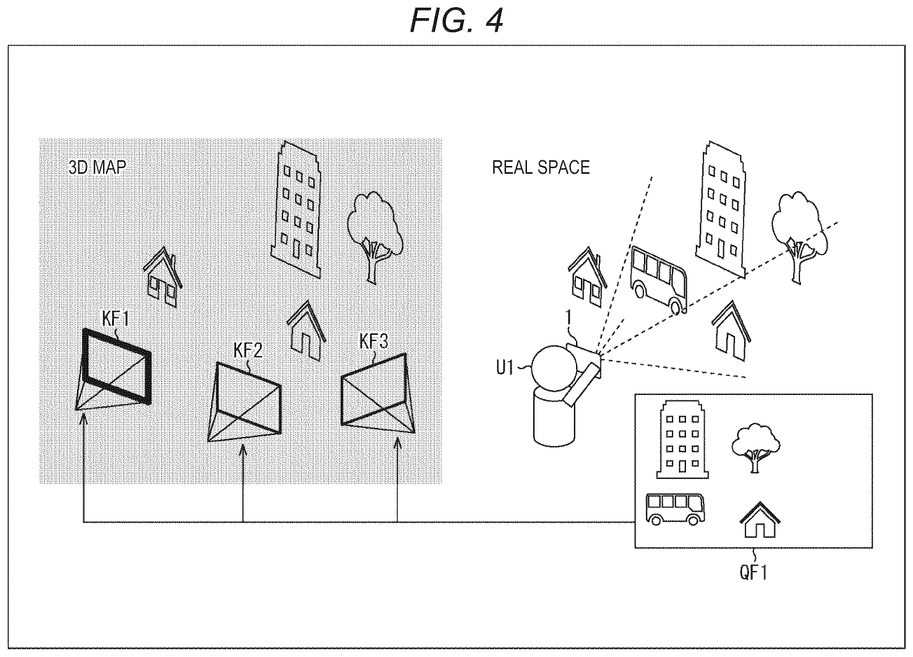

A flow of localization will be described with reference to FIGS. 4 to 6. Localization is mainly performed by three steps.

When localization is started, as illustrated on the right side of FIG. 4, a query image QF1 obtained by imaging a real space is acquired by a user terminal 1 used by an application user U1. When the query image QF1 is captured, first, as indicated by an arrow in FIG. 4, each of the key frames KF1 to KF3 included in the 3D map is compared with the query image QF1, and an image most similar to the query image QF1 is selected from the key frames KF1 to KF3. For example, the key frame KF1 indicated by a thick line in FIG. 4 is selected.

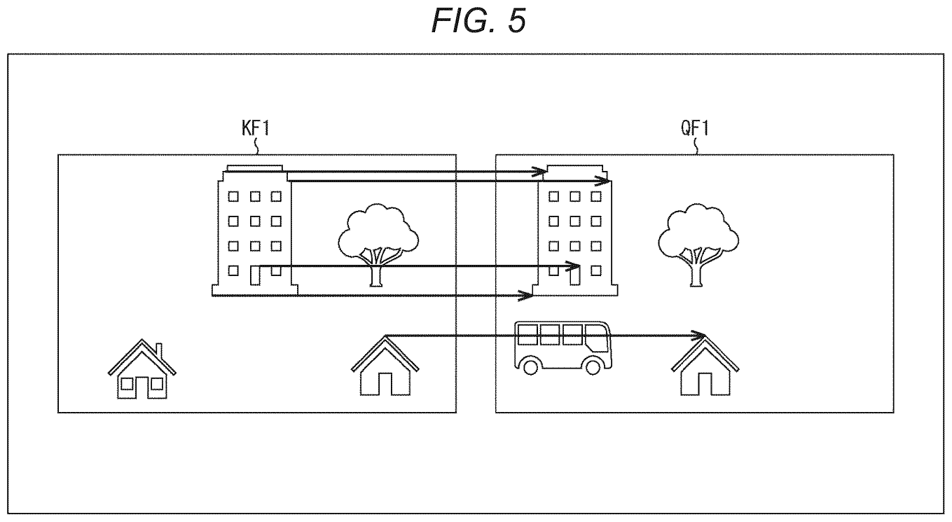

Next, as indicated by the arrows in FIG. 5, the correspondence of the key points is searched between the selected key frame KF1 and the query image QF1.

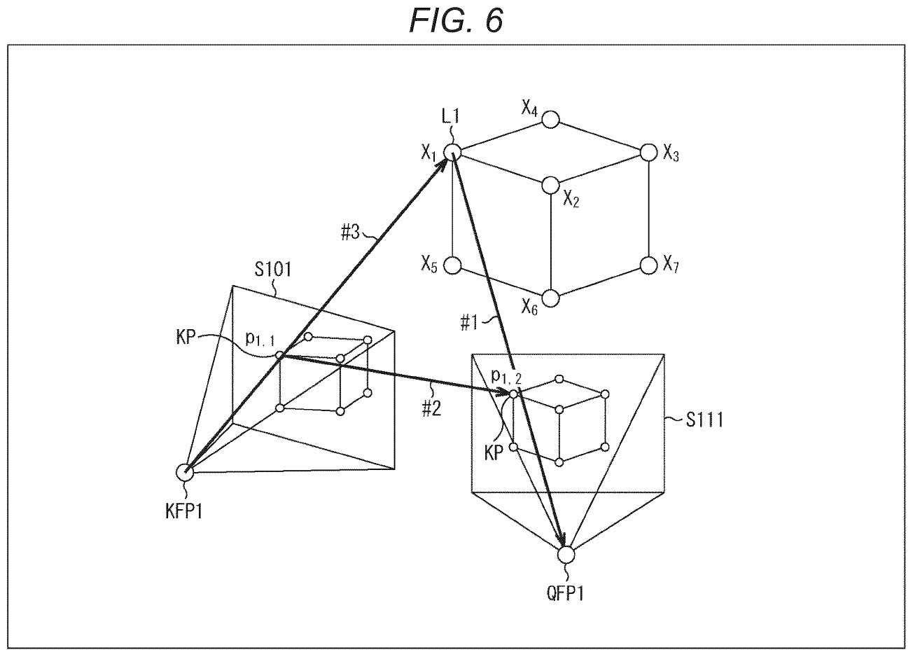

Next, as illustrated in FIG. 6, the viewpoint (imaging position and imaging direction) of the query image QF1 is estimated on the basis of the correspondence of the key points between the key frame KF1 and the query image QF1 and the landmark positions corresponding to the key points.

The image planes S101 and S111 illustrated in FIG. 6 indicate virtual image planes on which the key frame KF1 and the query image QF1 obtained by imaging the same cube in different positions and postures are projected. The landmark L1 commonly appears in the key frame KF and the query image QF1. In the two-dimensional coordinate system of the key frame, the position of the key point KP in the key frame KF1 corresponding to the landmark L1 is indicated by p_{1,1}, and the position of the key point KP in the query image QF1 is indicated by p_{1,2}.

Since the landmark position x₁ of the landmark L1 is known, the KF viewpoint of the query image QF1 is estimated by performing optimization calculation to obtain the imaging position QFP1 and the imaging direction of the query image QF1 on the basis of the landmark position x₁ and the position of the key point KP on the image plane S111 as indicated by arrow #1. In the optimization calculation for obtaining the KF viewpoint of the query image QF1, the positional relationship of the key point KP between the key frame KF1 and the query image QF1 indicated by arrow #2, and the positional relationship of the imaging position KFP1, the position of the key point on the image plane S101, and the landmark position x₁ indicated by arrow #3 are also used.

Actually, localization cannot be performed anywhere in the real space corresponding to the 3D map, and there are places where localization is likely to succeed and places where localization is likely to fail.

A main cause of a place where localization is likely to fail is considered to be an environment not suitable for localization and a shortage of key frames included in the 3D map.

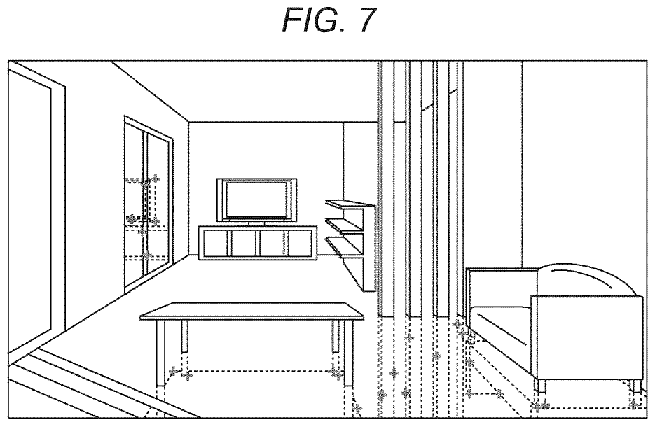

FIG. 7 is a diagram illustrating an example of an environment unsuitable for localization.

An environment having a mirror surface or glass as illustrated in FIG. 7 is not suitable for localization. In FIG. 7, an object reflected on a mirror surface or glass is indicated by a broken line. As indicated by a cross in FIG. 7, an object reflected on a mirror surface or glass may also be specified as a landmark.

Since the state of the object reflected in the mirror surface or the glass changes depending on the imaging position, it is not possible to accurately search for the correspondence of the key points between the key frame and the query image, and there is a high possibility that localization fails. Furthermore, localization is likely to fail in a dark environment in which no landmark is shown in the query image, an environment in which there is no feature to be a landmark such as being surrounded by a monochrome wall or floor, an environment in which similar patterns such as lattice patterns are continuous, and the like. In an environment without a mirror surface or the like, sufficiently bright, and having many unique features, localization is likely to succeed.

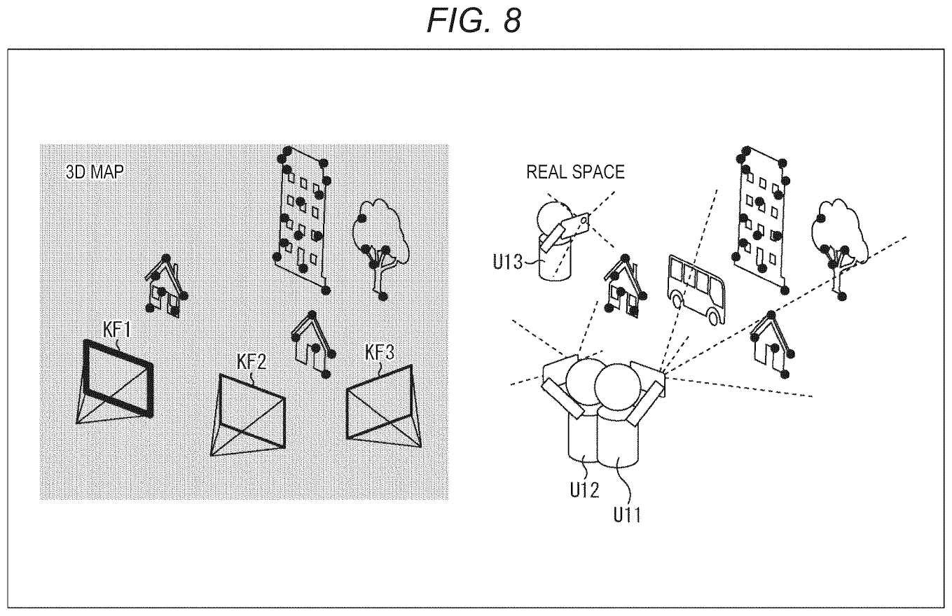

FIG. 8 is a diagram illustrating an example in which localization fails due to a shortage of key frames included in the 3D map.

As illustrated on the left side of FIG. 8, it is assumed that the 3D map includes three key frames KF1 to KF3. In FIG. 8, black dots shown in parts of buildings and trees indicate landmarks appearing in the key frames KF1 to KF3.

In the real space, the landmark sufficiently appears in the query image captured by an application user U11 illustrated on the right side of FIG. 8, and thus the localization of the place of the application user U11 is likely to succeed.

The query image captured by an application user U12 does not include enough landmarks, in other words, the 3D map does not include enough key frames obtained by capturing landmarks corresponding to key points in the query image. Since a key frame similar to the query image cannot be selected, localization for the place of the application user U12 is likely to fail.

The query image captured by an application user U13 shows the same object as the object appearing in the key frames KF1 to KF3, but the key frames captured from the direction similar to the query image are not included in the 3D map. In other words, no valid landmark appears in the query image. Therefore, localization for the place of the application user U13 is likely to fail.

As described above, localization using the query image captured from a viewpoint similar to the KF viewpoint of the key frames included in the 3D map to some extent is likely to succeed, and localization using the query image captured from a viewpoint significantly different from the KF viewpoint of the key frames is likely to fail.

In the case of developing an AR application using the VPS technology, if a place where localization is likely to succeed and a place where localization is likely to fail are known, the application developer can arrange the AR virtual object in a place where localization is likely to succeed. Furthermore, in a case where the place where the AR virtual object is desired to be arranged is a place where localization is likely to succeed, the application developer can arrange the AR virtual object at the place.

In a case where the AR virtual object is arranged at a place where localization is likely to fail, there is a possibility that the position and the posture of the user terminal cannot be estimated even if the query image is captured at the place, and the AR virtual object cannot be displayed on the user terminal. Therefore, the application developer can implement a measure not to arrange the AR virtual object in a place where localization is likely to fail.

In a case where there is a place where localization is likely to fail due to an environment not suitable for localization, the application developer can take measures on the environment side. For example, the application developer can implement measures such as covering the mirror surface portion to make the mirror surface invisible or attaching a poster, a sticker, or the like to a wall having no feature so as to create a feature.

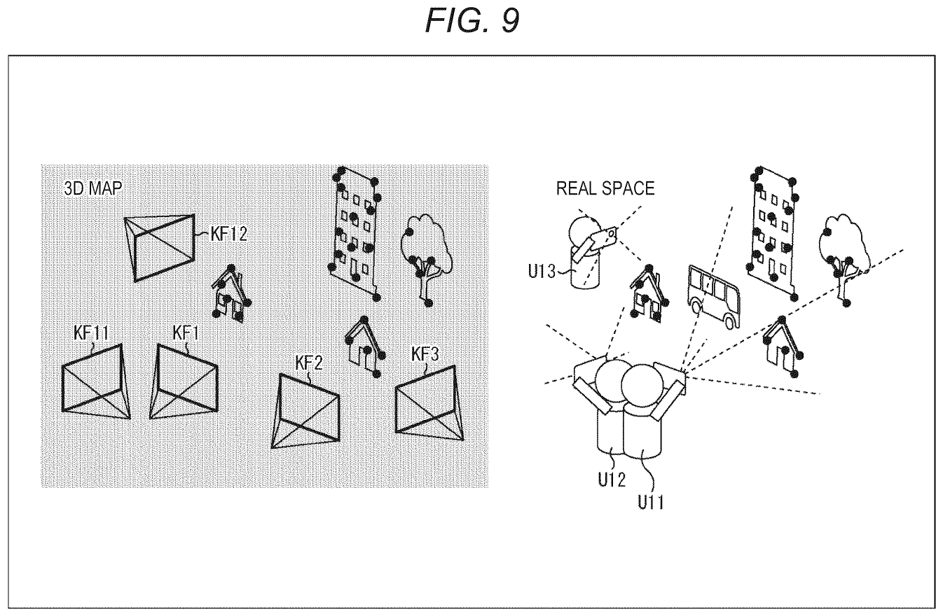

Furthermore, in a case where there is a place where localization is likely to fail due to a shortage of the key frames included in the 3D map, the application developer can add a group of newly captured key frames near the place where localization is likely to fail to the 3D map, as illustrated in FIG. 9.

The 3D map of FIG. 9 includes key frames KF11 and KF12 in addition to the key frames KF1 to KF3 included in the 3D map of FIG. 8. The key frame KF11 is a key frame captured near the place of the application user U12 illustrated on the right side of FIG. 9, and the key frame KF12 is a key frame captured near the place of the application user U13.

Since the 3D map includes the key frames KF11 and KF12, localization of the places of the application user U12 and the application user U13 is likely to succeed. By adding a group of newly imaged key frames to the 3D map, it is possible to set a place where localization is likely to fail to be a place where localization is likely to succeed.

In a case where a place where localization is likely to fail occurs due to an environment that does not meet localization, the application developer can easily determine, by actually viewing the environment, which place is likely to succeed in localization and which place is likely to fail in localization.

The 3D map is not, like a general map, in a format that can be understood by a person, but is held in a form of a machine-readable database. Therefore, in a case where there is a place where localization is likely to fail due to a shortage of the key frames included in the 3D map, it is difficult for the application developer (in particular, a person other than the developer of the VPS algorithm) to determine which place is likely to succeed in localization and which place is likely to fail in localization.

By going to the real space corresponding to the 3D map and actually performing localization, it is possible to confirm whether the place is a place where localization is likely to succeed or the place where localization is likely to fail, but it takes time and effort to actually go to the real space corresponding to the 3D map.

There is also a method of visualizing information included in a 3D map in a format that can be understood by a person to check a place where localization is likely to succeed and a place where localization is likely to fail. For example, a group of points indicating a KF viewpoint and a landmark is visualized. In this method, it is not necessary to actually go to the area in which the 3D map is prepared, but it is difficult for a person who does not understand the algorithm of the VPS technology to determine a place where localization is likely to succeed and a place where localization is likely to fail.

Furthermore, in this method, a place where localization is likely to succeed and a place where localization is likely to fail can be determined only qualitatively.

### 2. First Embodiment

### Outline of First Embodiment

As described above, in a case where there is a place where localization is likely to fail due to a shortage of the key frames included in the 3D map, it is difficult for the application developer to determine which place is likely to succeed in localization and which place is likely to fail in localization.

Therefore, an embodiment of the present technology proposes a technology capable of easily confirming a place where localization is likely to succeed and a place where localization is likely to fail by calculating an imaging target direction of a landmark included in a 3D map, acquiring a virtual viewpoint of a user with respect to the 3D map, drawing a first image showing a state of the 3D map, and superimposing a second image based on the imaging target direction of the landmark and the virtual viewpoint on the first image.

As described with reference to FIG. 8, the place where localization is likely to fail is a place where a query image not sufficiently including valid landmarks is captured. In the first embodiment of the present technology, the 3D map is visualized so that the application developer can determine whether the valid landmark is sufficiently included in the query image captured in a certain arbitrary position and posture.

Specifically, the 3D map is visualized on the basis of the imaging target direction which is the direction of the landmark with respect to the imaging position of the key frame in which the landmark appears.

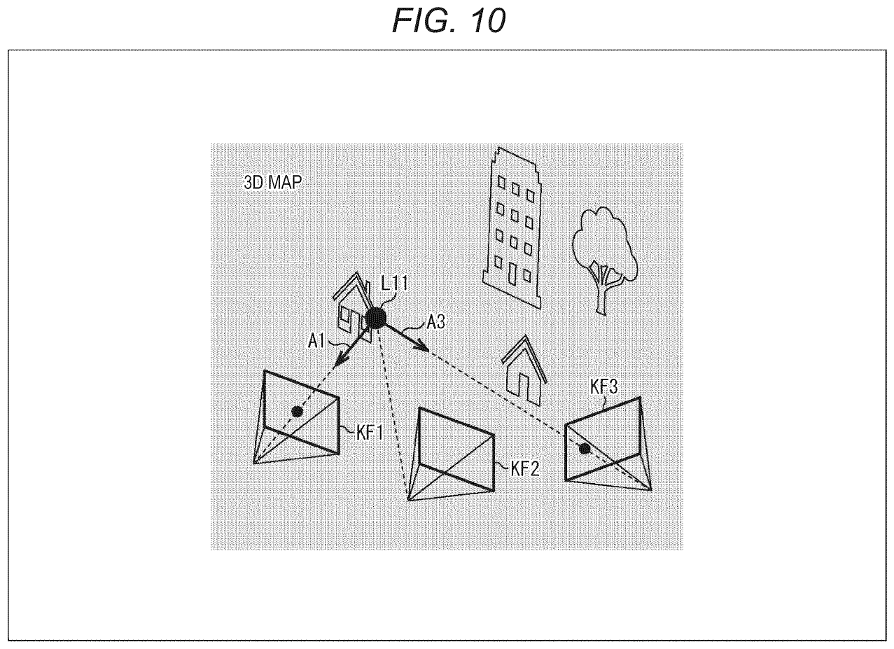

FIG. 10 is a diagram illustrating an example of an imaging target direction of a landmark.

In the example of FIG. 10, a landmark L11 appears in the key frames KF1 and KF3 among the three key frames KF1 to KF3 included in the 3D map. In FIG. 10, the imaging target direction of the landmark L11 for the key frame KF1 is indicated by arrow A1, and the imaging target direction of the landmark L11 for the key frame KF3 is indicated by arrow A3. The imaging target direction of the landmark is calculated on the basis of the landmark position and the KF viewpoint of the key frame in which the landmark appears. In a case where one landmark appears in a plurality of key frames, the landmark has a plurality of imaging target directions.

Hereinafter, arranging the environment mesh included in the 3D map on the 3D space and displaying the virtual viewpoint image indicating the state of the 3D map (environment mesh) viewed from the virtual viewpoint (position and posture) set by the application developer is referred to as a 3D view.

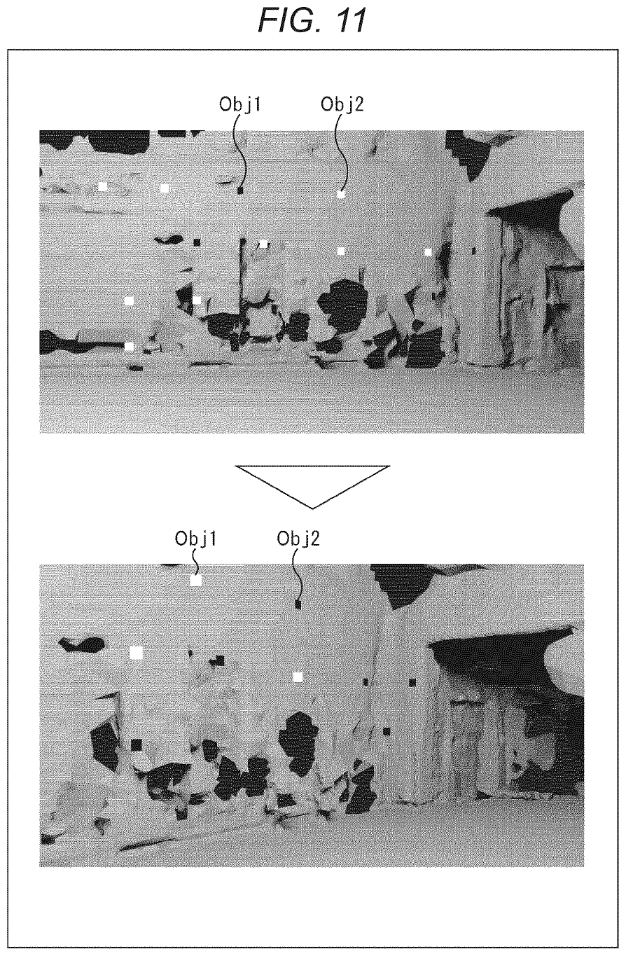

FIG. 11 is a diagram illustrating a display example of a 3D view.

In the 3D view, as illustrated in the upper side of FIG. 11, rectangular objects (landmark objects) indicating landmarks are arranged on the environment mesh. Note that the shape of the landmark object is not limited to a rectangle, and may be, for example, a circle or a sphere.

In a case where there is a key frame imaged from the same direction as the direction of the virtual viewpoint in the key frame in which the landmark appears, the landmark object indicating the landmark is displayed in green, for example. In other words, the landmark object displayed in green indicates a landmark that is effective when the query image is captured from the viewpoint (real viewpoint) of the real space corresponding to the virtual viewpoint. On the other hand, in a case where there is no key frame imaged from the direction of the virtual viewpoint in the key frame in which the landmark appears, the landmark object indicating the landmark is displayed in gray, for example.

In FIG. 11, valid landmarks in the virtual viewpoint are indicated by white landmark objects, and landmarks that are not valid in the virtual viewpoint are indicated by black landmark objects.

In the 3D view illustrated in the upper side of FIG. 11, for example, a landmark object Obj1 is displayed in black (gray), and a landmark object Obj2 is displayed in white (green). When the virtual viewpoint is changed, as illustrated in the lower side of FIG. 11, the landmark object Obj1 is displayed in white (green), and the landmark object Obj2 is displayed in black (gray).

By viewing the 3D view while changing the virtual viewpoint and confirming the number of green landmark objects, the application developer can determine whether or not the real viewpoint corresponding to the virtual viewpoint is likely to succeed in localization.

### Configuration of Information Processing Device

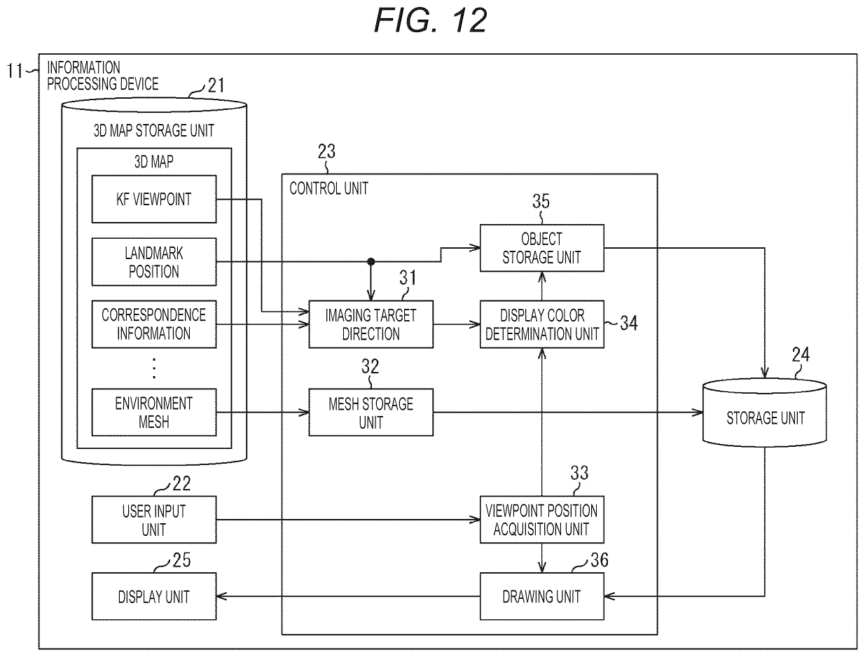

FIG. 12 is a block diagram illustrating a configuration example of an information processing device 11 according to the first embodiment of the present technology.

The information processing device 11 in FIG. 12 is a device that displays a 3D view for confirming whether a valid landmark appears in a query image captured from a real viewpoint corresponding to a virtual viewpoint. For example, the application developer is a user of the information processing device 11.

As illustrated in FIG. 12, the information processing device 11 includes a 3D map storage unit 21, a user input unit 22, a control unit 23, a storage unit 24, and a display unit 25.

The 3D map storage unit 21 stores a 3D map. The 3D map includes a KF viewpoint, a landmark position, correspondence information, an environment mesh, and the like. Note that, for example, point group data other than the environmental mesh may be included in the 3D map as the information indicating the shape of the real space.

The user input unit 22 includes a mouse, a game pad, a joystick, and the like. The user input unit 22 receives an input of an operation for setting a virtual viewpoint in the 3D space. The user input unit 22 supplies information indicating the input operation to the control unit 23.

The control unit 23 includes an imaging target direction calculation unit 31, a mesh arrangement unit 32, a viewpoint position acquisition unit 33, a display color determination unit 34, an object arrangement unit 35, and a drawing unit 36.

The imaging target direction calculation unit 31 acquires the KF viewpoint, the landmark position, and the correspondence information from the 3D map stored in the 3D map storage unit 21, and calculates the imaging target direction of the landmark on the basis of these pieces of information. The imaging target direction calculation unit 31 supplies the imaging target direction of the landmark to the display color determination unit 34. Details of a method of calculating the imaging target direction of the landmark will be described later.

The mesh arrangement unit 32 acquires the environment mesh from the 3D map. The mesh arrangement unit 32 arranges the environmental mesh in the 3D space virtually formed on the storage unit 24. In a case where the information indicating the shape of the environment included in the 3D map is the point group data, the mesh arrangement unit 32 arranges the point group indicated by the point group data in the 3D space.

The viewpoint position acquisition unit 33 sets a virtual viewpoint in the 3D space on the basis of the information supplied from the user input unit 22, and supplies information indicating the virtual viewpoint to the display color determination unit 34 and the drawing unit 36.

The display color determination unit 34 determines the color of the landmark object on the basis of the imaging target direction of the landmark calculated by the imaging target direction calculation unit 31 and the virtual viewpoint set by the viewpoint position acquisition unit 33, and supplies information indicating the color of the landmark object to the object arrangement unit 35. A method of determining the color of the landmark object will be described later.

The object arrangement unit 35 acquires the landmark position from the 3D map, and arranges the landmark object of the color determined by the display color determination unit 34 at the landmark position on the environmental mesh in the 3D space.

The drawing unit 36 draws a virtual viewpoint image indicating a state of the 3D map viewed from the virtual viewpoint determined by the viewpoint position acquisition unit 33, and supplies the virtual viewpoint image to the display unit 25. The drawing unit 36 also functions as a presentation control unit that presents a virtual viewpoint image to the application developer.

The storage unit 24 is provided, for example, in a partial storage area of a random access memory (RAM). In the storage unit 24, a 3D space in which an environment mesh and a landmark object are arranged is virtually formed.

The display unit 25 includes a display provided in a PC, a tablet terminal, a smartphone, or the like, a monitor connected to these devices, or the like. The display unit 25 displays the virtual viewpoint image supplied from the drawing unit 36.

Note that the 3D map storage unit 21 may be provided in a cloud server connected to the information processing device 11. In this case, the control unit 23 acquires information included in the 3D map from the cloud server.

### Operation of Information Processing Device

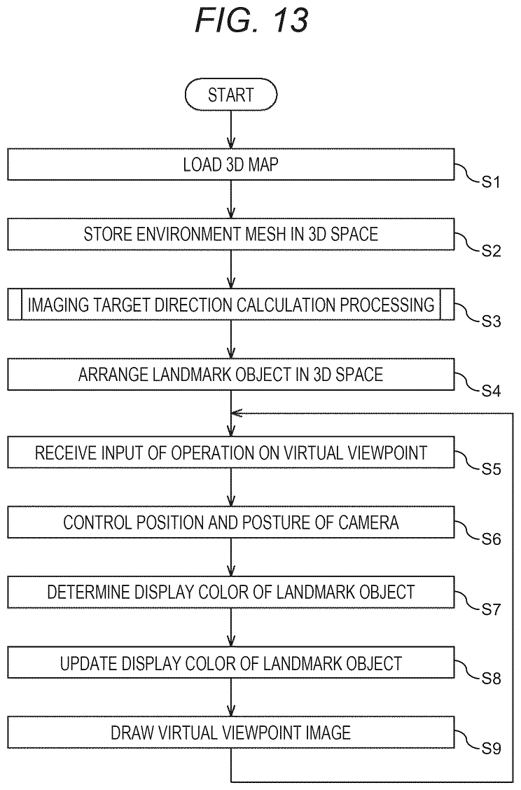

Next, the process performed by the information processing device 11 having the above-mentioned configuration will be described with reference to a flowchart of FIG. 13.

In step S1, the control unit 23 loads the 3D map stored in the 3D map storage unit 21.

In step S2, the mesh arrangement unit 32 arranges the environmental mesh in the 3D space.

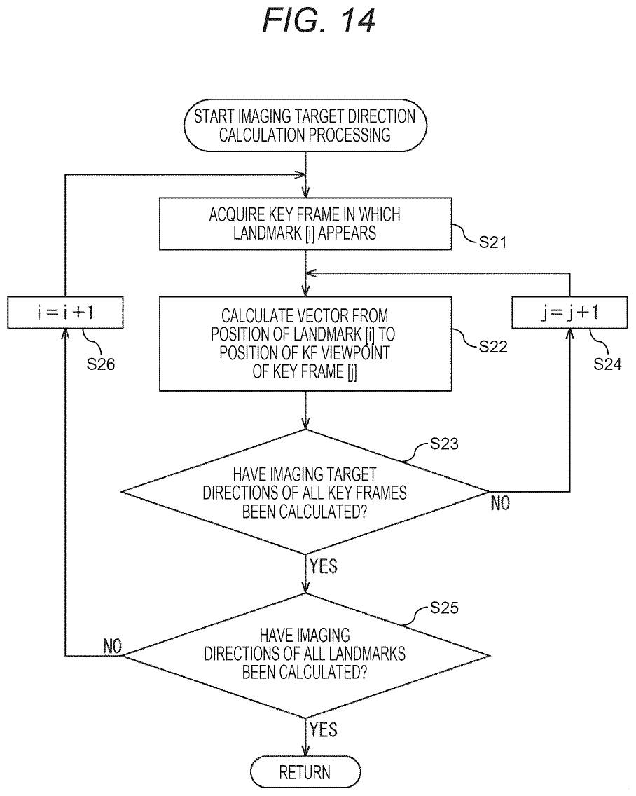

In step S3, the imaging target direction calculation unit 31 performs imaging target direction calculation processing. By the imaging target direction calculation processing, the imaging target direction of each landmark included in the 3D map is calculated. Details of the imaging target direction calculation processing will be described later with reference to FIG. 14. Note that the imaging target direction of each landmark calculated at the time of generating the 3D map may be included in the 3D map. In this case, the imaging target direction calculation unit 31 acquires the imaging target direction of each landmark from the 3D map.

In step S4, the object arrangement unit 35 arranges the landmark object at the landmark position on the environment map in the 3D space.

In step S5, the user input unit 22 accepts an input of an operation related to the virtual viewpoint

In step S6, the viewpoint position acquisition unit 33 sets the virtual viewpoint and controls the position and the posture of the virtual camera for drawing the virtual viewpoint image on the basis of the operation received by the user input unit 22.

In step S7, the display color determination unit 34 determines the display color of the landmark object on the basis of the virtual viewpoint and the imaging target direction of the landmark.

In step S8, the object arrangement unit 35 updates the display color of the landmark object.

In step S9, the drawing unit 36 draws the virtual viewpoint image. The virtual viewpoint image drawn by the drawing unit 36 is displayed on the display unit 25. Thereafter, the processes of steps S5 to S9 are repeatedly performed.

Next, the imaging target direction calculation processing performed in step S3 in FIG. 13 is described with reference to a flowchart in FIG. 14.

In step S21, the imaging target direction calculation unit 31 acquires the KF viewpoint of the key frame in which the landmark [i] appears.

In step S22, the imaging target direction calculation unit 31 calculates a vector from the landmark position of the landmark [i] to the position of the KF viewpoint of the key frame [j] as the imaging target direction of the landmark [i]. Assuming that xᵢ is the landmark position of the landmark [i] and pⱼ is the KF viewpoint of the key frame [j], the imaging target direction vᵢ is expressed by the following Expression (1).

$$[ Math . 1 ]$$

$${v}_{i} = {p}_{i} - {x}_{i} \qquad ( 1 )$$

$${p}_{i} ∈ {3}^{} , {x}_{i} ∈ {3}^{}$$

In step S23, the imaging target direction calculation unit 31 determines whether or not the imaging target directions for all the key frames in which the landmark [i] appears have been calculated.

In a case where it is determined in step S23 that the imaging target directions have not been calculated for all the key frames in which the landmark [i] appears, the imaging target direction calculation unit 31 increments j (j=j+1) in step S24. Thereafter, the process returns to step S22, and the process of step S22 is repeatedly performed until the imaging target directions for all the key frames in which the landmark [i] appears are calculated.

On the other hand, in a case where it is determined in step S23 that the imaging target directions have been calculated for all the key frames in which the landmarks [i] appear, in step S25, the imaging target direction calculation unit 31 determines whether or not the imaging target directions of all the landmarks have been calculated.

In a case where it is determined in step S25 that the imaging target directions of all the landmarks have not been calculated, the imaging target direction calculation unit 31 increments i (i=i+1) in step S26. Thereafter, the process returns to step S21, and the processes of steps S21 to S23 are repeatedly performed until the imaging target directions of all the landmarks are calculated. On the other hand, in a case where it is determined in step S25 that the imaging target directions of all the landmarks have been calculated, the process returns to step S3 in FIG. 13, and the subsequent process is performed.

As described above, in the information processing device 11, the virtual viewpoint image (first image) indicating the state of the 3D map viewed from the virtual viewpoint on which the second image including the landmark object drawn in the color according to the imaging target direction is superimposed is presented to the application developer. The landmark object is drawn in a color based on an imaging target direction of the landmark, such as green or gray. By viewing the 3D view while changing the virtual viewpoint and confirming the number of green landmark objects, the application developer can easily determine whether or not localization for the virtual viewpoint is likely to succeed.

### Method of Determining Display Color of Landmark Object

In a case where the imaging target direction of the landmark is toward the position of the virtual viewpoint, it is considered that the landmark appears in the key frame captured from the KF viewpoint similar to the virtual viewpoint, and it can be said that the landmark is effective for the virtual viewpoint.

In other words, it can be said that the smaller the angle formed by the imaging target direction of the landmark and the direction of the virtual viewpoint, the more effective the landmark is. Assuming that the vector of the imaging target direction of the landmark [i] is vᵢ and the vector of the direction of the virtual viewpoint is c, an angle θ formed by (the opposite direction of) the imaging target direction of the landmark [i] and the direction of the virtual viewpoint is expressed by the following Expression (2).

$$[ Math . 2 ]$$

$$θ = {cos}^{- 1} \frac{- {v}_{i} \cdot c}{‖ {v}_{i} ‖ ‖ c ‖} \qquad ( 2 )$$

$${v}_{i} ∈ {3}^{} , c ∈ {3}^{}$$

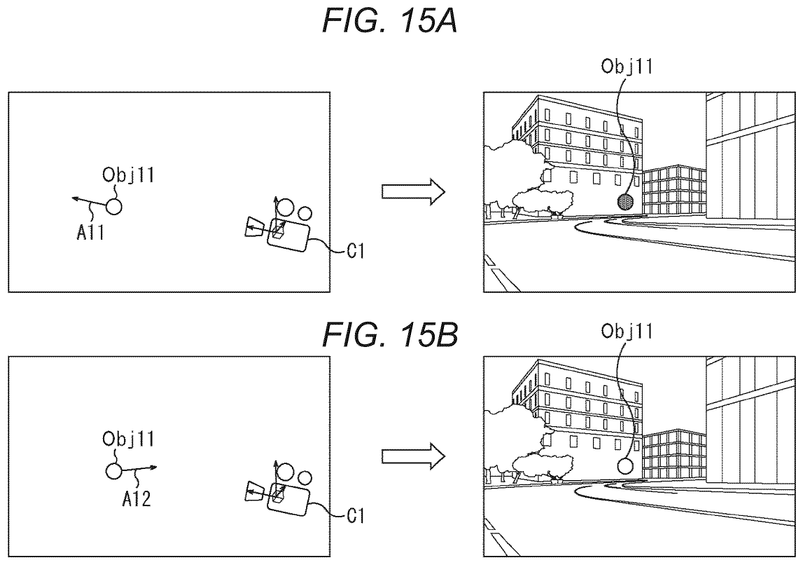

FIG. 15 is a diagram illustrating an example of a display color of a landmark object.

On the left side of A of FIG. 15, arrow A11 illustrates an example in which the imaging target direction of the landmark indicated by a landmark object Obj11 is opposite to the direction toward a camera C1 for drawing the virtual viewpoint image in which the landmark object Obj11 appears.

As illustrated on the left side of A of FIG. 15, in a case where the angle formed by (the opposite direction of) the imaging target direction of the landmark indicated by the landmark object Obj11 and the direction of the virtual viewpoint is larger than a threshold, the landmark is not valid for the virtual viewpoint. Therefore, as illustrated on the right side of A of FIG. 15, the gray landmark object Obj11 is displayed in the 3D view.

On the left side of B of FIG. 15, arrow A12 illustrates an example in which the imaging target direction of the landmark indicated by the landmark object Obj11 is a direction toward the vicinity of the camera C1.

As illustrated on the left side of B of FIG. 15, in a case where the angle formed by (the opposite direction of) the imaging target direction of the landmark indicated by the landmark object Obj11 and the direction of the virtual viewpoint is smaller than the threshold, the landmark is valid for the virtual viewpoint. Therefore, as illustrated on the right side of B of FIG. 15, the green (indicated by white in FIG. 15) landmark object Obj11 is displayed in the 3D view.

As described above, the landmark object is drawn in a color corresponding to the angle formed by the imaging target direction of the landmark and the direction of the virtual viewpoint. How small the angle formed by the imaging target direction of the landmark and the direction of the virtual viewpoint is to enable the landmark for the virtual viewpoint depends on a localization algorithm. Therefore, the threshold used to determine the display color of the landmark object is appropriately set by the localization algorithm. Note that the color of the landmark object may change with gradation according to the angle formed by the imaging target direction of the landmark and the direction of the virtual viewpoint.

### Modifications

### <Example Considering Shielding by Building or the Like>

Landmarks sufficiently far from the position of the virtual viewpoint and landmarks invisible (shielded) hidden by objects such as buildings from the virtual viewpoint are not used for localization. Therefore, the landmark object indicating such a landmark may not be displayed in the 3D view.

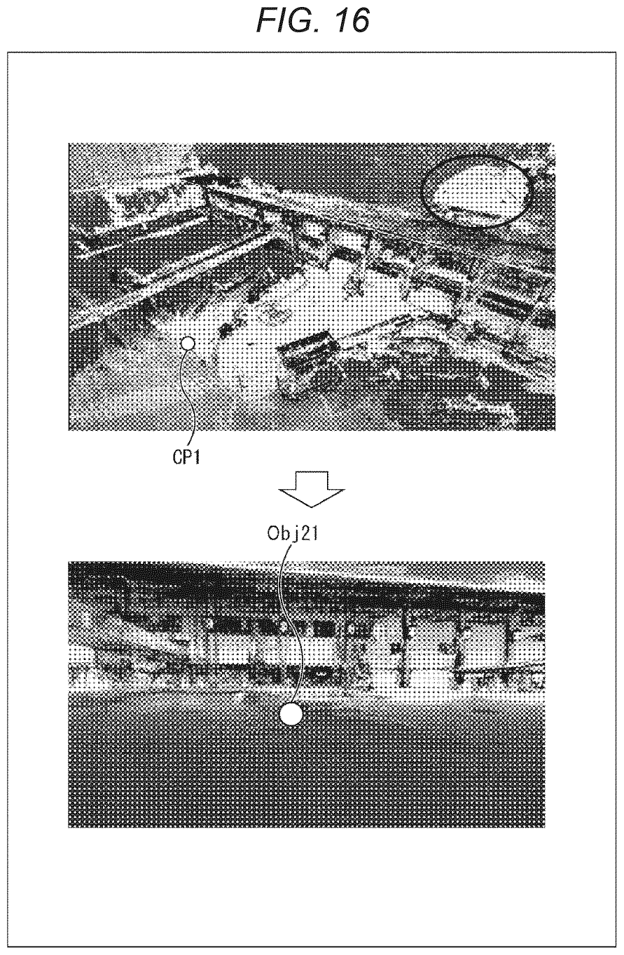

FIG. 16 is a diagram illustrating an example of an overhead view of a 3D map and a virtual viewpoint image.

In the 3D map illustrated on the upper side of FIG. 16, a landmark exists in a portion surrounded by an ellipse, but even when viewed from a virtual viewpoint CP1, the landmark object indicating the landmark cannot be viewed because the landmark is shielded by a building existing therebetween. In a case where the shape of the real space is indicated by the point group data in the 3D map, there is a possibility that the landmark object indicating the landmark is seen through between the point groups when viewed from the virtual viewpoint CP1.

Therefore, the information processing device 11 arranges the mesh at the position of the building existing between the landmark and the virtual viewpoint CP1. By arranging the mesh, as illustrated in the lower side of FIG. 16, in the 3D view, a landmark object Obj21 that is not shielded by the building or the like is displayed, but the landmark object shielded by the building is not displayed.

Furthermore, the information processing device 11 calculates the distance between the position of the virtual viewpoint and the landmark position, and does not display the landmark object in a case where the distance is equal to or more than a threshold.

As described above, by preventing the landmarks (landmark objects) not used for localization from being displayed in the 3D view, for example, it is possible to prevent the application developer from erroneously recognizing that there are many valid landmarks when viewing the landmarks not used for localization.

<Example of Expressing Imaging Target Direction with Color of Landmark Object>

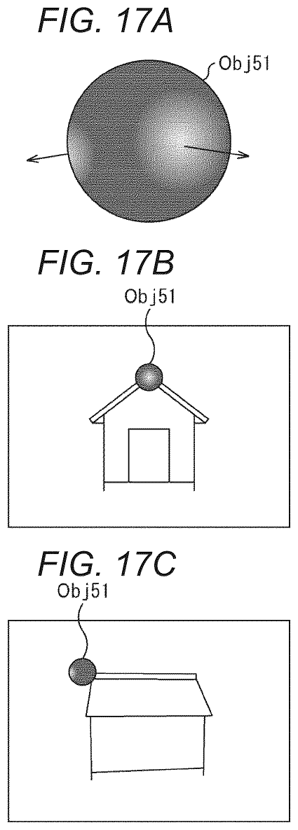

FIG. 17 is a diagram illustrating an example of a landmark object expressing an imaging target direction with a color.

As illustrated in A of FIG. 17, the shape of a landmark object Obj51 is spherical, and in the spherical surface, a portion facing the imaging target direction indicated by an arrow is drawn in a light color, and a portion not facing the imaging target direction is drawn in a dark color. In practice, for example, a portion facing the imaging target direction on the spherical surface (a portion where the normal direction coincides with the imaging target direction) is drawn in green, and the color changes to red with gradation as the normal direction of the spherical surface moves away from the imaging target direction.

As illustrated in B of FIG. 17, in a case where the building is viewed from the front side in the 3D view, since the entire light color portion is visible on the spherical surface of the landmark object Obj51, it can be seen that the imaging target direction is toward the position of the virtual viewpoint.

As illustrated in C of FIG. 17, in a case where the building is viewed from the side surface side in the 3D view, since a part of the light color is seen on the left side of the spherical surface of the landmark object Obj51, it can be seen that the imaging target direction is directed to the left side as viewed from the virtual viewpoint.

As described above, a portion of the landmark object whose normal direction coincides with the imaging target direction of the landmark may be drawn in a color indicating the imaging target direction of the landmark. By expressing the imaging target direction with the color of the landmark object, it is possible to confirm the imaging target direction of the landmark while viewing the 3D view. In a case where the imaging target direction is expressed by the color of the landmark object, the virtual viewpoint is not used to determine the color of the landmark object. Note that the shape of the landmark object may be a shape other than a spherical shape (for example, a shape of a polyhedron). In a case where the shape of the landmark object is a polyhedron, for example, a surface of the polyhedron whose normal direction coincides with the imaging target direction of the landmark is drawn in a color indicating the imaging target direction of the landmark.

<Example of Expressing Imaging Target Direction with Shape of Landmark Object>

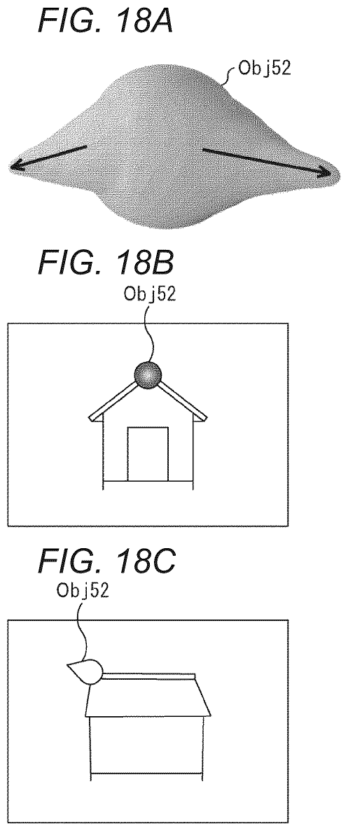

FIG. 18 is a diagram illustrating an example of a landmark object that expresses an imaging target direction with a shape.

As illustrated in A of FIG. 18, the shape of a landmark object Obj52 is a spherical shape in which a spherical portion facing an imaging target direction indicated by an arrow protrudes in a protruding shape.

As illustrated in B of FIG. 18, in a case where the building is viewed from the front side in the 3D view, the shadow of the landmark object Obj52 can be seen to protrude toward the position side of the virtual viewpoint, so that it can be seen that the imaging target direction is toward the position of the virtual viewpoint.

As illustrated in C of FIG. 18, in a case where the building is viewed from the side surface in the 3D view, since it can be seen that the landmark object Obj52 protrudes leftward as viewed from the virtual viewpoint, it can be seen that the imaging target direction is leftward as viewed from the virtual viewpoint.

As described above, the landmark object may be drawn in a shape indicating the imaging target direction of the landmark. By expressing the imaging target direction with the shape of the landmark object, it is possible to confirm the imaging target direction of the landmark while viewing the 3D view. In a case where the imaging target direction is expressed by the shape of the landmark object, the virtual viewpoint is not used to determine the shape of the landmark object.

### <Example of AR Display of Landmark Object>

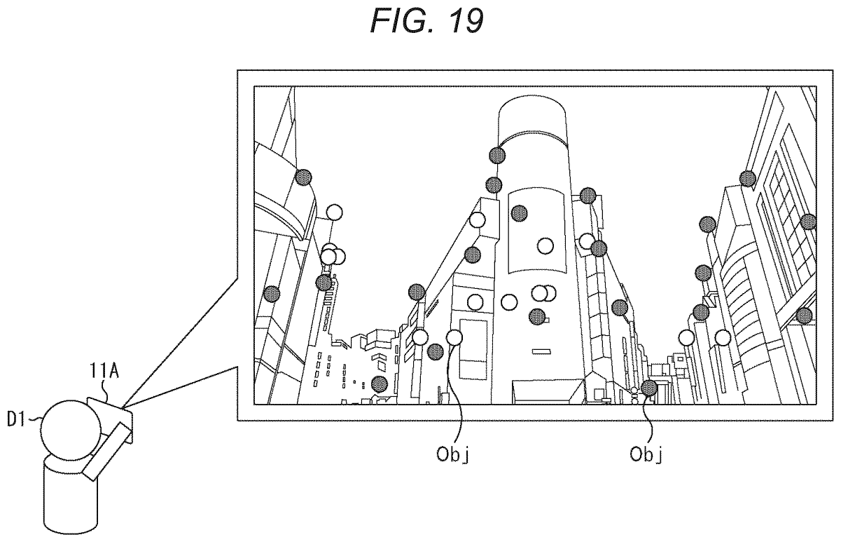

FIG. 19 is a diagram illustrating an example of performing the AR display of the landmark object.

It is assumed that when an application developer D1 actually goes to the area in which the 3D map is prepared, a captured image is captured with a tablet terminal 11A as the information processing device 11 facing the surroundings. In this case, as illustrated in a word balloon in FIG. 19, a landmark object Obj displayed in a virtual viewpoint image having the imaging position and the imaging direction of the captured image as the virtual viewpoint may be superimposed on the captured image and displayed on the display of the tablet terminal 11A.

Note that the imaging position and the imaging direction of the captured image may be acquired by a sensor provided in the tablet terminal 11A, or may be estimated using the VPS technology.

### <Example of Calculating Localization Score>

A score (localization score) indicating the degree of localization ease may be calculated, and information according to the localization score may be displayed in the 3D view.

In the VPS technology, as many valid landmarks appear in the query image, localization tends to succeed. Therefore, the localization score is calculated on the basis of the number of landmarks appearing in the virtual viewpoint image, the angle formed by the imaging target direction of each landmark and the direction of the virtual viewpoint, the distance from the position of the virtual viewpoint to each landmark position, the image feature amount of the key point corresponding to the landmark, and the like. For example, a value obtained by summing angles formed by the imaging target direction of each landmark appearing in the virtual viewpoint image and the direction of the virtual viewpoint is set as the landmark score.

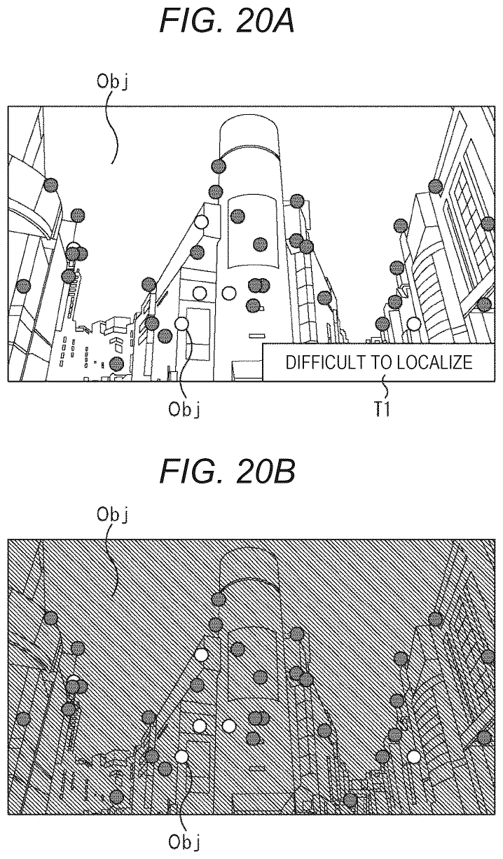

FIG. 20 is a diagram illustrating an example of a 3D view in which information according to a landmark score is displayed.

For example, in a case where the landmark score is equal to or lower than the threshold, as illustrated in A of FIG. 20, in the 3D view, a text T1 of “difficult to localize” is displayed superimposed on the virtual viewpoint image.

Furthermore, for example, in a case where the landmark score is equal to or less than the threshold, the entire color of the virtual viewpoint image is changed and displayed as hatched in B of FIG. 20. Note that, in a case where the landmark score is equal to or less than the threshold, the color of a part of the screen of the 3D view may be changed.

The color of the entire virtual viewpoint image or the color of a part of the screen of the 3D view may be changed according to the landmark score. For example, as the landmark score decreases, a part of the screen of the 3D view changes to yellow or red. The landmark score may be displayed directly on the screen of the 3D view.

### 3. Second Embodiment

### Outline of Second Embodiment

In the second embodiment of the present technology, the localization score is calculated for each grid obtained by dividing the entire 3D map, and the heat map corresponding to the localization score for each grid is displayed.

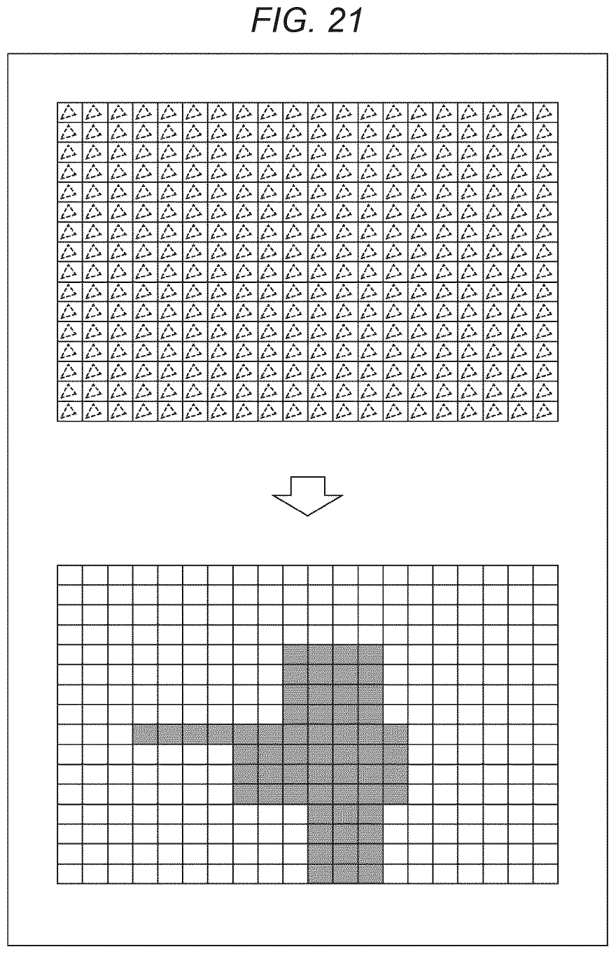

FIG. 21 is a diagram illustrating an example of a method of generating a heat map.

As illustrated in the upper side of FIG. 21, in the information processing device 11, the 3D map viewed from a certain viewpoint (for example, an overhead viewpoint including the entire 3D map in the visual field) is divided into a plurality of grids, and the direction of the virtual viewpoint (evaluation direction) is set for each grid by the application developer. Note that the application developer may set one direction as the evaluation direction in all the grids. In the example of FIG. 21, a dashed triangle in each grid indicates that the direction from the center of the grid toward the upper right of the grid is the evaluation direction.

The localization score for each grid is calculated on the basis of the evaluation direction set by the application developer, and as illustrated in the lower side of FIG. 21, a heat map in which grids are drawn in colors corresponding to the localization score is generated. For example, a grid having a high localization score is drawn in green, a grid having a medium localization score is drawn in yellow, and a grid having a low localization score is drawn in red.

The heat map is displayed to be superimposed on an overhead image showing a state of a 3D map (environment mesh) viewed from an overhead viewpoint when the grid is divided. Hereinafter, displaying a heat map corresponding to an overhead image so as to be superimposed on the overhead image is referred to as a heat map view.

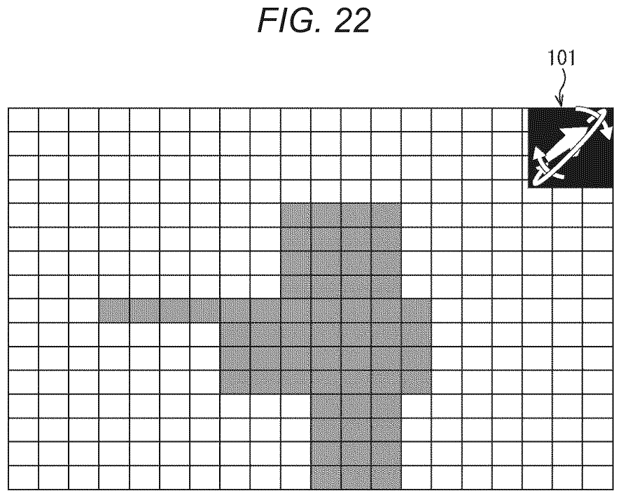

FIG. 22 is a diagram illustrating an example of a UI for inputting an operation of setting an evaluation direction.

As illustrated in FIG. 22, for example, an arrow user interface (UI) 101 for inputting an operation of orienting all the evaluation directions set for each of the grids in the same direction is superimposed and displayed on the upper right side of the heat map. The application developer can change the evaluation direction by changing the direction of arrow UI101 using a mouse operation or a touch operation. For example, the direction of arrow UI101 is the evaluation direction as it is. Arrow UI101 can change its direction not only in the horizontal direction but also in the vertical direction.

By viewing the color of the grid in the heat map view while operating the direction of arrow UI101, the application developer can confirm where and from which direction the query image is captured so that localization is likely to succeed or localization is likely to fail.

### Configuration of Information Processing Device

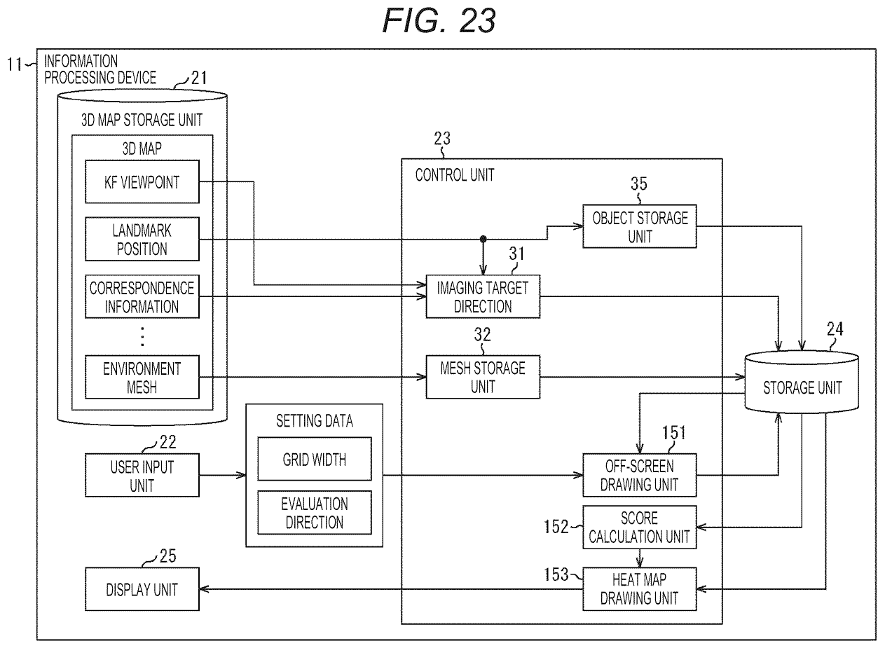

FIG. 23 is a block diagram illustrating a configuration example of an information processing device 11 according to the second embodiment of the present technology. In FIG. 23, the same components as the components in FIG. 12 are denoted by the same reference signs. Redundant description will be omitted as appropriate.

The information processing device 11 in FIG. 23 is different from the information processing device 11 in FIG. 12 in that the viewpoint position acquisition unit 33, the display color determination unit 34, and the drawing unit 36 are not provided, and an off-screen drawing unit 151, a score calculation unit 152, and a heat map drawing unit 153 are provided.

The information processing device 11 in FIG. 23 is a device that displays a heat map view for checking the ease of localization for each grid obtained by dividing the entire 3D map.

The user input unit 22 receives an input of an operation for setting the width and the evaluation direction of the grid. The user input unit 22 supplies setting data indicating the width and the evaluation direction of the grid set by the application developer to the control unit 23.

The imaging target direction calculation unit 31 supplies the imaging target direction of each landmark to the storage unit 24 and stores the imaging target direction.

The off-screen drawing unit 151 divides the 3D map viewed from a certain overhead viewpoint into a plurality of grids with a grid width set by the application developer. The off-screen drawing unit 151 determines a virtual viewpoint for each grid, and draws, for each grid, a virtual viewpoint image indicating a state of a 3D map (environment mesh) viewed from the virtual viewpoint. Note that the virtual viewpoint image is drawn off-screen.

The position of the virtual viewpoint for each grid is, for example, the center of the grid and is a position at a predetermined height from the ground in the environmental mesh. The center of the grid is determined on the basis of the grid width set by the application developer. The direction of the virtual viewpoint for each grid is the evaluation direction determined by the application developer.

The off-screen drawing unit 151 supplies a result of off-screen drawing for each grid to the storage unit 24 and stores the result.

The score calculation unit 152 acquires a result of off-screen drawing for each grid from the storage unit 24, and calculates a localization score for each grid on the basis of the result of off-screen drawing. For example, the score calculation unit 152 detects a landmark object appearing in the virtual viewpoint image as a result of off-screen drawing, and calculates a localization score on the basis of the number of detected landmark objects, the imaging target direction of the landmark indicated by the landmark object, and the like.

The format of the landmark object arranged in the 3D space may be any format as long as the score calculation unit 152 can detect the landmark object. As the metadata of the landmark object, information (correspondence information indicating correspondence with key point, imaging target direction, etc.) corresponding to the landmark may be held, or information corresponding to the landmark may be held in another format.

The score calculation unit 152 supplies the calculated localization score for each grid to the heat map drawing unit 153.

The heat map drawing unit 153 draws the heat map on the basis of the localization score for each grid calculated by the score calculation unit 152. The heat map drawing unit 153 draws an overhead image showing a state of a 3D map viewed from an overhead viewpoint when the grid is divided, superimposes the heat map on the overhead image, and supplies the superimposed heat map to the display unit 25. The drawing unit 36 also functions as a presentation control unit that presents the application developer with the overhead image on which the heat map is superimposed.

The display unit 25 displays the image supplied from the heat map drawing unit 153. A UI for inputting an operation of setting the evaluation direction, such as arrow UI, is also presented by the display unit 25 under the control of the heat map drawing unit 153, for example.

### Operation of Information Processing Device

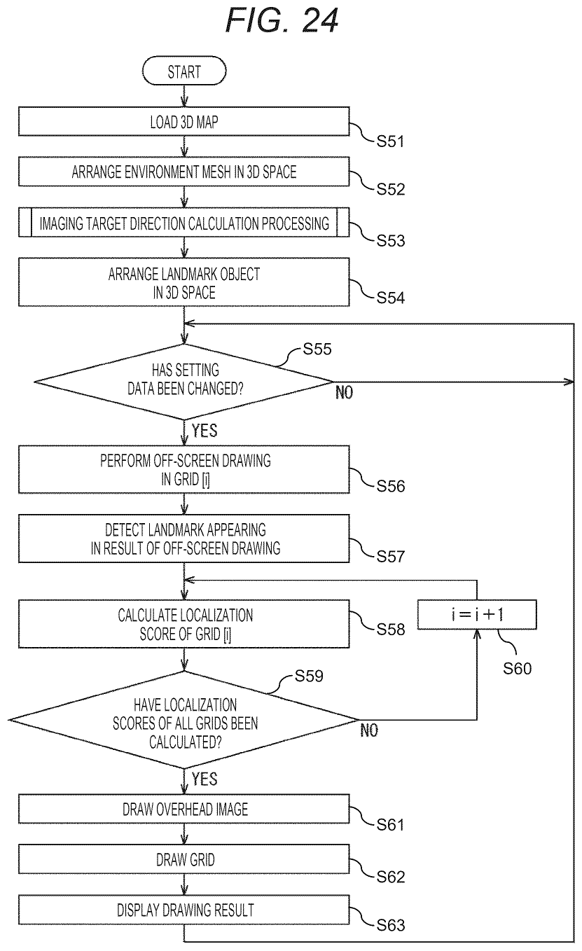

Next, the process performed by the information processing device 11 having the above-mentioned configuration will be described with reference to a flowchart of FIG. 24.

The processes of steps S51 to S54 are similar to the processes of steps S1 to S4 in FIG. 13.

In step S55, the control unit 23 determines whether or not the setting data has been changed, and waits until the setting data is changed. For example, in a case where the application developer changes the grid width and the evaluation direction by operating the user input unit 22, it is determined that the setting data has been changed. In a case where the grid width and the evaluation direction are set for the first time, the process proceeds similarly to the case where the setting data is changed.

In a case where it is determined in step S55 that the setting data has been changed, in step S56, the off-screen drawing unit 151 performs off-screen drawing on the grid [i].

In step S57, the score calculation unit 152 detects a landmark (landmark object) appearing in the result of off-screen drawing.

In step S58, the score calculation unit 152 calculates the localization score of the grid [i] on the basis of the number of landmarks appearing in the off-screen drawing result and the like.

In step S59, the score calculation unit 152 determines whether or not the localization scores of all the grids have been calculated.

In a case where it is determined in step S59 that the localization scores of all the grids have not been calculated, the score calculation unit 152 increments i (i=i+1) in step S60. Thereafter, the process returns to step S58, and the process of step S58 is repeatedly performed until the localization scores of all the grids are calculated.

On the other hand, in a case where it is determined in step S59 that the localization scores of all the grids have been calculated, in step S61, the heat map drawing unit 153 draws an overhead image illustrating a state of the 3D map viewed from the overhead viewpoint when the grids are divided.

In step S62, the heat map drawing unit 153 draws a grid in a color corresponding to the localization score on the overhead image.

In step S63, the display unit 25 displays the drawing result by the heat map drawing unit 153. Thereafter, the processes of steps S56 to S63 are repeatedly performed each time the setting data is changed.

As described above, in the information processing device 11, the overhead image (first image) on which the heat map (second image) indicating the ease of localization in color is superimposed for each of the grids into which the 3D map viewed from the overhead viewpoint is divided is presented to the application developer. By viewing the color of the grid in the heat map view while changing the evaluation direction, the application developer can confirm where and from which direction the query image is captured to easily succeed in localization or easily fail.

### Modifications

### <Example of UI for Inputting Operation of Setting Evaluation Direction>

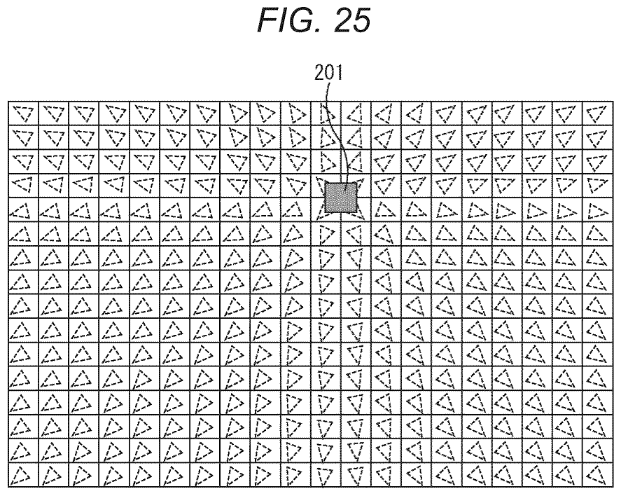

FIG. 25 is a diagram illustrating another example of the UI for inputting the operation of setting the evaluation direction.

As illustrated in FIG. 25, a target object 201 of interest may be arranged and displayed on a heat map (grid) as a UI that allows an application developer to change a position. The evaluation direction for each grid is set to, for example, a direction from the center of each grid toward the center of the target object of interest (one point of the overhead image).

<Example in which a Plurality of Evaluation Directions is Set>

A plurality of evaluation directions may be set for each grid. In this case, the application developer does not need to set the evaluation direction.

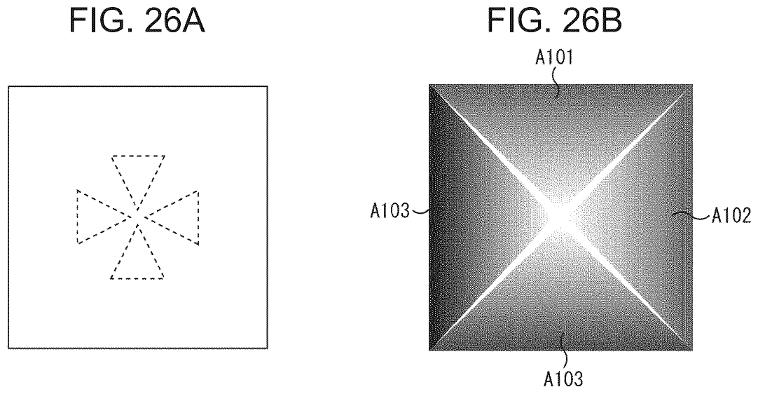

FIG. 26 is a diagram illustrating an example of a plurality of evaluation directions set for each grid.

As indicated by four broken triangle in A of FIG. 26, for example, four evaluation directions of upper, lower, left, and right are set for one grid. In this case, off-screen drawing in which each of the four evaluation directions is set as the direction of the virtual viewpoint is performed for one grid, and four localization scores are calculated.

In a case where four localization scores are calculated for each grid, as illustrated in B of FIG. 26, one grid is divided into four areas A101 to A104 on the upper, lower, left, and right sides, and the areas A101 to 104 respectively corresponding to the four evaluation directions on the upper, lower, left, and right sides are drawn in colors corresponding to the localization scores.

<Example of Calculating Localization Score without Performing Off-Screen Drawing>

Only the ID of the landmark appearing in the virtual viewpoint image viewed from the virtual viewpoint in the grid [i] and the metadata of the uv coordinate on the virtual viewpoint image may be stored in the storage unit 24 without performing the off-screen drawing, and the localization score may be calculated on the basis of the ID of the landmark and the metadata of the uv coordinate. For example, the image feature amount and the imaging target direction associated with the landmark ID are acquired and used to calculate the localization score.

### <<Computer>>

The series of processing steps described above can be executed by hardware and also can be executed by software. In a case where the series of processing steps is executed by software, a program included in the software is installed from a program recording medium on a computer incorporated in dedicated hardware, a general-purpose personal computer, or the like.

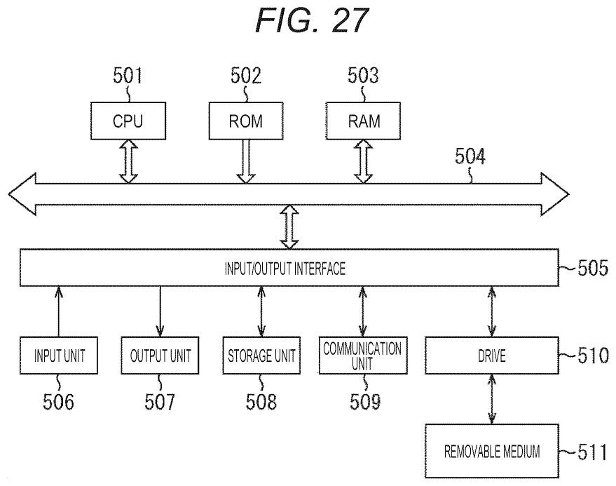

FIG. 27 is a block diagram illustrating a configuration example of hardware of a computer that executes the above-described series of processes by a program.

A central processing unit (CPU) 501, a read only memory (ROM) 502, and a random access memory (RAM) 503 are connected to each other by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to execute the above-described series of processing.

For example, the program executed by the CPU 501 is recorded in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present description, or may be a program in which the processing is performed in parallel or at a necessary timing such as when a call is made.

Note that the effects described in the present description are merely examples and are not limited, and other effects may be provided.

The embodiments of the present technology are not limited to the above-described embodiments, and various modifications can be made without departing from the scope of the present technology.

For example, the present technology may be configured as cloud computing in which a function is shared by a plurality of devices through the network to process together.

Furthermore, each step described in the above-described flowcharts can be executed by one device, or can be shared and executed by a plurality of devices.

Moreover, in a case where a plurality of processes is included in one step, the plurality of processes included in the one step can be shared and executed by a plurality of devices in addition to being executed by one device.

### Combination Examples of Configurations

The present technology can also be configured as follows.

(1)

An information processing device including:
an imaging target direction calculation unit that calculates an imaging target direction of a landmark included in a 3D map generated on the basis of a plurality of captured images obtained by capturing an image of a real space;
a viewpoint acquisition unit that acquires a virtual viewpoint of a user for the 3D map; and
a drawing unit that draws a first image showing a state of the 3D map and superimposes a second image based on an imaging target direction of the landmark and the virtual viewpoint on the first image.
   (2)

The information processing device according to (1), in which
the second image is an image indicating ease of estimation of a real viewpoint using a real image captured from the real viewpoint that is a viewpoint of the real space corresponding to the virtual viewpoint and the 3D map.
   (3)

The information processing device according to (2), in which
the first image is a virtual viewpoint image showing a state of the 3D map viewed from the virtual viewpoint, and
the second image includes an object indicating the landmark.
   (4)

The information processing device according to (3), in which
the object is drawn in a color based on an imaging target direction of the landmark.
   (5)

The information processing device according to (4), in which
the object is drawn in a color corresponding to an angle formed by an imaging target direction of the landmark and a direction of the virtual viewpoint.
   (6)

The information processing device according to claim(4), in which
a portion of the object in which a normal direction coincides with an imaging target direction of the landmark is drawn in a color indicating the imaging target direction of the landmark.
   (7)

The information processing device according to (3), in which
the object is drawn in a shape indicating an imaging target direction of the landmark.
   (8)

The information processing device according to any one of (3) to (7), in which
the drawing unit superimposes the object on the real image.
   (9)

The information processing device according to any one of (3) to (8), further including:
a presentation control unit that presents information according to a score indicating a degree of ease of estimation of the real viewpoint to the user together with the virtual viewpoint image on which the object is superimposed.
   (10)

The information processing device according to (2), in which
the first image is an overhead image showing a state of an entire region of the 3D map viewed from an overhead viewpoint, and the second image is a heat map indicating ease of estimation of the real viewpoint in color for each grid obtained by dividing the overhead image.
   (11)

The information processing device according to (10), further including:
a score calculation unit that calculates a score indicating a degree of ease of estimation of the real viewpoint for each of the grids on the basis of at least an imaging target direction of the landmark and the virtual viewpoint, in which
in the heat map, the grid is drawn in a color corresponding to the score.
   (12)

The information processing device according to (11), in which
the score calculation unit calculates the score corresponding to each of directions of a plurality of the virtual viewpoints on the basis of the directions of the plurality of virtual viewpoints set for each of the grids, and
in the heat map, a region in which the grid is divided according to the directions of the plurality of virtual viewpoints is drawn in a color corresponding to the corresponding score.
   (13)

The information processing device according to any one of (10) to (12), further including:
a presentation control unit that presents, to the user, a UI for inputting an operation of orienting all directions of the virtual viewpoints set for the respective grids in a same direction together with the overhead image on which the heat map is superimposed.
   (14)

The information processing device according to any one of (10) to (13), further including:
a presentation control unit that presents, to the user, a UI for inputting an operation of orienting a direction of the virtual viewpoint set for each of the grids to one point in the overhead image together with the overhead image on which the heat map is superimposed.
   (15)

An information processing method performed by an information processing device, including:
calculating an imaging target direction of a landmark included in a 3D map generated on the basis of a plurality of captured images obtained by capturing an image of a real space;
acquiring a virtual viewpoint of a user for the 3D map; and
drawing a first image showing a state of the 3D map and superimposing a second image based on an imaging target direction of the landmark and the virtual viewpoint on the first image.
   (16)

A program for causing a computer to execute:
calculating an imaging target direction of a landmark included in a 3D map generated on the basis of a plurality of captured images obtained by capturing an image of a real space;
acquiring a virtual viewpoint of a user for the 3D map; and
drawing a first image showing a state of the 3D map and superimposing a second image based on an imaging target direction of the landmark and the virtual viewpoint on the first image.

### REFERENCE SIGNS LIST

11 Information processing device
21 3D map storage unit
22 User input unit
23 Control unit
24 Storage unit
25 Display unit
31 Imaging target direction calculation unit
32 Mesh arrangement unit
33 Viewpoint position acquisition unit
34 Display color determination unit
35 Object arrangement unit
36 Drawing unit
151 Off-screen drawing unit
152 Score calculation unit
153 Heat map drawing unit

What is claimed is:

1. An information processing device comprising:
an imaging target direction calculation unit that calculates an imaging target direction of a landmark included in a 3D map generated on a basis of a plurality of captured images obtained by capturing an image of a real space;
a viewpoint acquisition unit that acquires a virtual viewpoint of a user for the 3D map; and
a drawing unit that draws a first image showing a state of the 3D map and superimposes a second image based on an imaging target direction of the landmark and the virtual viewpoint on the first image.

2. The information processing device according to claim 1, wherein
the second image is an image indicating ease of estimation of a real viewpoint using a real image captured from the real viewpoint that is a viewpoint of the real space corresponding to the virtual viewpoint and the 3D map.

3. The information processing device according to claim 2, wherein
the first image is a virtual viewpoint image showing a state of the 3D map viewed from the virtual viewpoint, and
the second image includes an object indicating the landmark.

4. The information processing device according to claim 3, wherein
the object is drawn in a color based on an imaging target direction of the landmark.

5. The information processing device according to claim 4, wherein
the object is drawn in a color corresponding to an angle formed by an imaging target direction of the landmark and a direction of the virtual viewpoint.

6. The information processing device according to claim 4, wherein
a portion of the object in which a normal direction coincides with an imaging target direction of the landmark is drawn in a color indicating the imaging target direction of the landmark.

7. The information processing device according to claim 3, wherein
the object is drawn in a shape indicating an imaging target direction of the landmark.

8. The information processing device according to claim 3, wherein
the drawing unit superimposes the object on the real image.

9. The information processing device according to claim 3, further comprising:
a presentation control unit that presents information according to a score indicating a degree of ease of estimation of the real viewpoint to the user together with the virtual viewpoint image on which the object is superimposed.

10. The information processing device according to claim 2, wherein
the first image is an overhead image showing a state of an entire region of the 3D map viewed from an overhead viewpoint, and the second image is a heat map indicating ease of estimation of the real viewpoint in color for each grid obtained by dividing the overhead image.

11. The information processing device according to claim 10, further comprising:
a score calculation unit that calculates a score indicating a degree of ease of estimation of the real viewpoint for each of the grids on a basis of at least an imaging target direction of the landmark and the virtual viewpoint, wherein
in the heat map, the grid is drawn in a color corresponding to the score.

12. The information processing device according to claim 11, wherein
the score calculation unit calculates the score corresponding to each of directions of a plurality of the virtual viewpoints on a basis of the directions of the plurality of virtual viewpoints set for each of the grids, and
in the heat map, a region in which the grid is divided according to the directions of the plurality of virtual viewpoints is drawn in a color corresponding to the corresponding score.

13. The information processing device according to claim 10, further comprising:
a presentation control unit that presents, to the user, a UI for inputting an operation of orienting all directions of the virtual viewpoints set for the respective grids in a same direction together with the overhead image on which the heat map is superimposed.

14. The information processing device according to claim 10, further comprising:
a presentation control unit that presents, to the user, a UI for inputting an operation of orienting a direction of the virtual viewpoint set for each of the grids to one point in the overhead image together with the overhead image on which the heat map is superimposed.

15. An information processing method performed by an information processing device, comprising:
calculating an imaging target direction of a landmark included in a 3D map generated on a basis of a plurality of captured images obtained by capturing an image of a real space;
acquiring a virtual viewpoint of a user for the 3D map; and
drawing a first image showing a state of the 3D map and superimposing a second image based on an imaging target direction of the landmark and the virtual viewpoint on the first image.

16. A program for causing a computer to execute:
calculating an imaging target direction of a landmark included in a 3D map generated on a basis of a plurality of captured images obtained by capturing an image of a real space;
acquiring a virtual viewpoint of a user for the 3D map; and
drawing a first image showing a state of the 3D map and superimposing a second image based on an imaging target direction of the landmark and the virtual viewpoint on the first image.
